(19) United States
(12) Patent Application Publication
(10) Pub. No.: US 2024/0059230 A1
(43) Pub. Date: Feb. 22, 2024

(54) ROLLING TOOL BOX LOCKDOWN KIT AND DEVICE

(71) Applicant: Michael Sargeant, Saint Augustine, FL (US)

(72) Inventor: Michael Sargeant, Saint Augustine, FL (US)

(21) Appl. No.: 17/888,992

(22) Filed: Aug. 16, 2022

(51) Int. Cl. B60R 11/06

(52) U.S. Cl. CPC B60R 11/06; B60R 2011/0059

(57) ABSTRACT

A lockdown kit and device for a load-bearing vehicle includes a base configured for attachment to a sidewall or a floor of the load-bearing vehicle. A latch is configured for attachment to the base. A lever is configured for movement from a first position to a second position, the lever engages with the latch to open and close the latch. A release cable is configured for attachment to the lever. The latch is configured for attachment to the base at a predetermined height for engagement with a clampable extension from a load including but not limited to a rolling toolbox.

### BACKGROUND

### Technical Field

The present disclosure generally relates to securing cargo, and more particularly, to a lockdown device for wheeled toolboxes.

### Description of the Related Art

Craftsmen in many fields transport tools and/or materials to jobsites. Such tools and/or materials are typically stored in a case or box. For example, a Milwaukee® rolling toolbox is one non-limiting example of a tool box having wheels to facilitate transport at various locations. However, when such toolboxes are transported in a van, flatbed or work trailer, securing the toolboxes becomes a challenge. Bungee cords or straps are typically used, which is a difficult way to secure such items and prevent shifting while being transported.

### SUMMARY

In one embodiment, a lockdown kit and device for a load-bearing vehicle includes a base configured for attachment to a sidewall or a floor of the load-bearing vehicle. A latch is configured for attachment to the base. A lever is configured for movement from a first position to a second position, the lever engages with the latch to open and close the latch. A release cable is configured for attachment to the lever.

In an embodiment, the release cable is configured to move the lever to open the latch.

In an embodiment, the latch is attached to the base at a predetermined height for engagement with a clampable extension from a load.

In an embodiment, the latch is attached to the base at a predetermined height for engagement with a grip portion or an eyelet of a load.

In an embodiment, the lockdown kit includes a solenoid configured to attach to the lever; and a reader configured to actuate the solenoid to move the lever from the first position to a second position upon receiving a signal from a fob.

In an embodiment, the lockdown kit includes a solenoid configured to attach to the release cable; and a reader configured to actuate the solenoid to move the release cable attached to the lever upon receiving a signal from a fob.

In an embodiment, the latch is a trunk latch from a motor vehicle.

In an embodiment, the release cable is a parking brake release cable from a motor vehicle.

In one embodiment, a toolbox lockdown device for a load-bearing vehicle includes a latch arranged at a predetermined height, a lever configured to engage and disengage the latch with a load based on a position of the lever, and a release cable attached to the lever configured to disengage the latch.

In an embodiment, the lever at a first position engages the latch with a clampable extension of the load, and the lever at a second position disengages the latch from the clampable extension of the load.

In an embodiment, a base is configured for attachment to a sidewall or a floor of the load-bearing vehicle, wherein the latch is attached to the base.

In an embodiment, the latch is attached to the base at a predetermined height for engagement with a clampable extension from a load.

In an embodiment, the latch is attached to the base at a predetermined height for engagement with a grip portion or an eyelet of a load.

In an embodiment, the base includes one or more support blocks.

In an embodiment, the release cable is configured to move the lever to open the latch.

In an embodiment, a solenoid configured to attach to the lever; and a reader configured to receive a signal from a fob and actuate the solenoid to move the lever from the first position to a second position.

In an embodiment, a solenoid configured to attach to the release cable; and a reader configured to receive a signal from a fob and actuate the solenoid to move the release cable attached to the lever.

In an embodiment, the latch is a trunk latch from a motor vehicle.

In an embodiment, the release cable is a parking brake release cable.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1 illustrates a perspective view of a lockdown device according to an illustrative embodiment of the present disclosure.

FIG. 2 illustrates a perspective view of a load according to an illustrative embodiment of the present disclosure.

FIG. 3 illustrates the lockdown device and an aligned load according to an illustrative embodiment of the present disclosure.

FIG. 4 illustrates a clampable extension of the load engaged with the lockdown device according to an illustrative embodiment of the present disclosure.

FIG. 5 shows a rolling toolbox load locked down according to an illustrative embodiment of the present disclosure.

FIG. 6 is a schematic of the lockdown device including a fob and a solenoid according to the present disclosure.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings.

As used herein, the term “load-bearing vehicle” is not limited to a particular type of vehicle. For example, the bed of a pickup truck, cargo area of a truck, and a boat or an aircraft, are all non-limiting possibilities. The lockdown kit and device is applicable in a wide variety of applications on land, sea and in the air.

The term “load” is not limited to a particular type of load. The terms “toolbox” and “rolling toolbox” non-limiting examples of one of the many types of loads that can be secured according the lockdown kit and device of the present disclosure. A toolbox having wheels, such as a Milwaukee® rolling toolbox, is one known-limiting example of a toolbox in which an eyelet can be engaged/disengaged with a latch of the lockdown device. The term “clampable extension” refs to any type of cord, cable, eyelet attached to a cable that may be attached to the load. A “grip portion” is any type of handle, ring, loop, groove that may be part of a load to facilitate movement and/or storage. The term “latch” is any type of mechanism that can secure an item, such as a cable, an eyelet, handle, etc. and includes manual or electro-mechanically operable latches. A key, or handle can actuate the latch, as well as a solenoid in conjunction with a wireless key fob or a button.

The lockdown device may also be provided as a kit, with the parts arranged by an installer or the purchaser in the load-bearing vehicle.

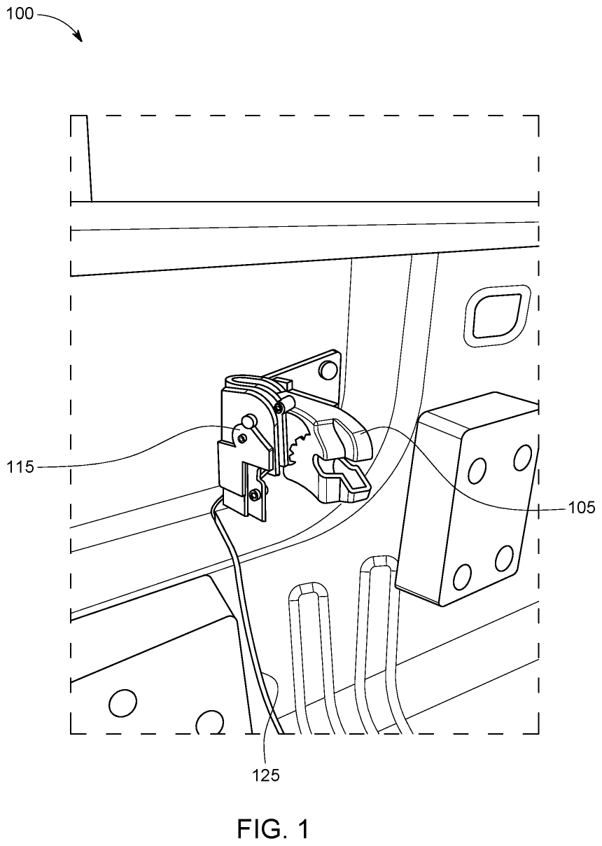

FIG. 1 illustrates a perspective view of a lockdown device 100 according to an illustrative embodiment of the present disclosure. Referring now to FIG. 1, the lockdown device 100 includes a latch 105, a lever 115, and a release cable 125. It is to be understood that the latch shown in provided for illustrated purposes only, and other forms of a latch may be used. The latch 105 is shown in an open position, and is actuated between an open position and a closed position by movement of the lever 115. The release cable 125 can be used to change the position of the lever to close the latch. In FIG. 1, the lock device is attached to the sidewall of a load-bearing vehicle such as a pickup truck bed. However, the lockdown device can be attached to the floor of the bed, and/or to a base, such as a support block. The latch can be attached at a predetermined height to engage with an eyelet, cable, a grip portion, or any other type of clampable extension of a load.

It is to be understood that while the lockdown device is shown attached to the sidewall of the load-bearing vehicle, it is within the purview of the claimed subject matter that the lockdown device can be attached to a post with a plurality of openings. Through the use of, for example, a spring loaded pin, the lockdown device can be adjusted to different heights by being slid along the post and then releasing the spring loaded pin to secure the lockdown device into place.

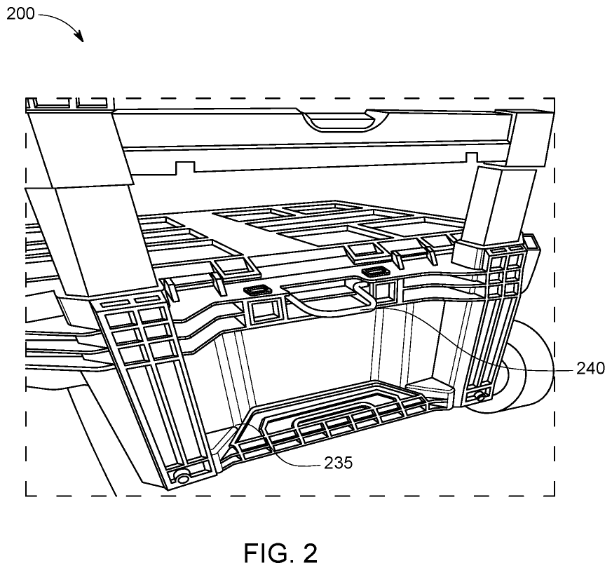

FIG. 2 illustrates a perspective view 200 of a load 235 according to an illustrative embodiment of the present disclosure. The load 235 shown in FIG. 2 has a clampable extension 240, such as a cable, that engages with the latch 105 shown in FIG. 1. It is to be understood that the claimed subject matter can be used to lockdown virtually any type of load having a clampable extension.

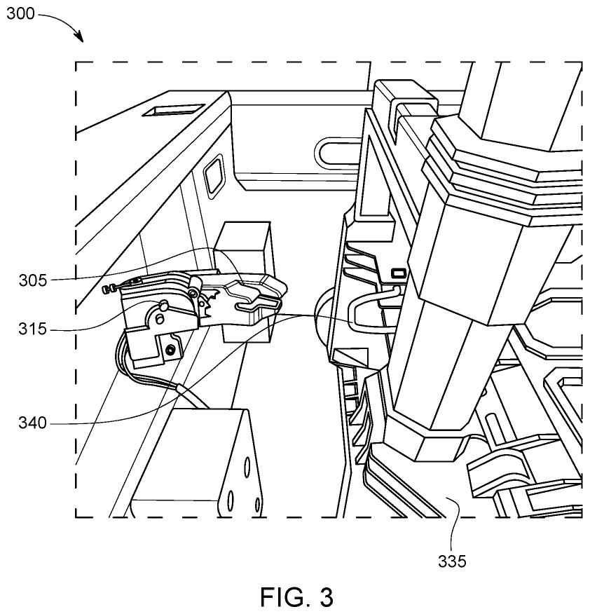

FIG. 3 illustrates the lockdown device 300 and an aligned load 335 according to an illustrative embodiment of the present disclosure. It is shown in FIG. 3 that the latch 305 is arranged at a predetermined height sufficient to engage with the clampable extension 340 of the load upon movement of the lever 315. The load 335 can be slid toward the lockdown device 300 such that the clampable extension 340 is arranged within the opening of the latch 315.

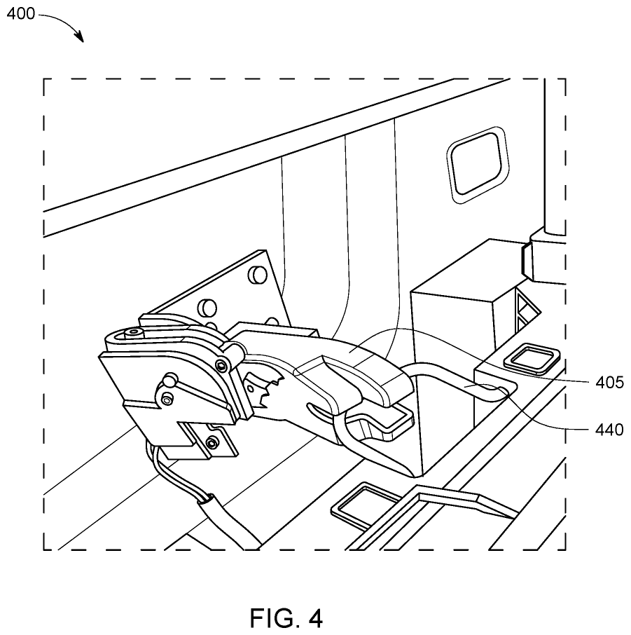

FIG. 4 illustrates a clampable extension of the load engaged with the lockdown device 400 according to an illustrative embodiment of the present disclosure. The load shown in FIG. 3 has been slid toward the lockdown device 400 so that the clampable extension 405 is arranged within the latch 405. It can also be seen that the latch 405 is in the closed position so that the load is secured to the latch 405.

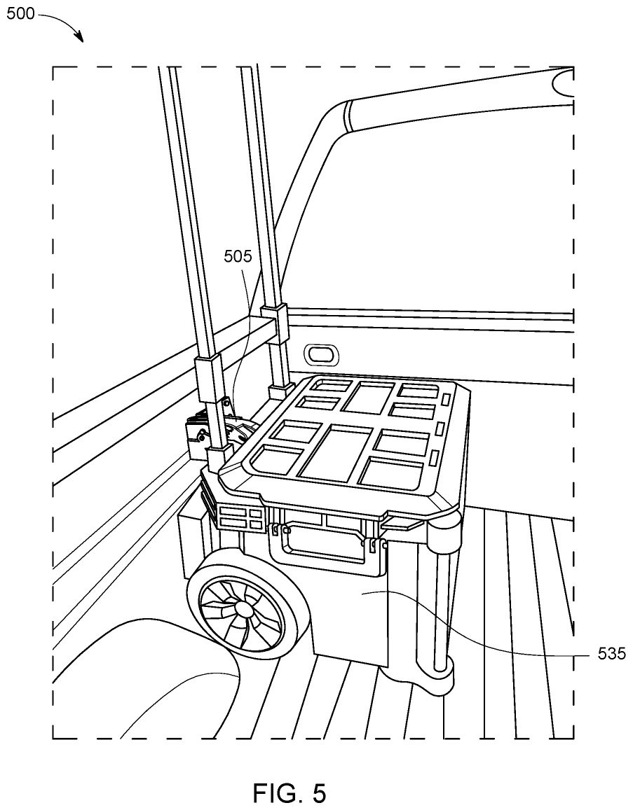

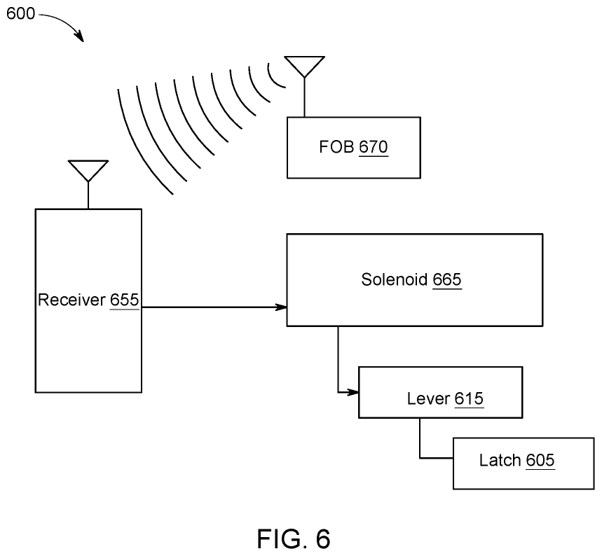

FIG. 5 shows a rolling toolbox 535 load locked down by the lockdown device 500 according to an illustrative embodiment of the present disclosure. The latch 505 has secured the load 535. By pulling on a release cable (see FIG. 1 element 125), the latch may be opened so the load is disengaged from the lockdown device 500. While the release cable of FIG. 1 is shown is in one embodiment, a brake cable that is manually actuated, a solenoid and fob may be used, such as discussed herein in FIG. 6.

FIG. 6 is a schematic of the lockdown device 600 including a fob and a solenoid according to the present disclosure. In this illustrative embodiment, a fob 670 sends a wireless signal to receiver 655, which is a fob reader. With a matching code, the receiver sends a signal to actuate the solenoid 665 The solenoid in turn moves the lever 615, that changes the position of the latch from open to closed, or vice versa.

It is also to be understood that while a fog 6570 is shown in FIG. 6, the signal to open the latch can be send by a smartphone, table, smartwatch, voice activated unit, optical signal, etc.

### CONCLUSION

The descriptions of the various embodiments of the lockdown device according to present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments of the disclosure are also contemplated. There are also embodiments of the disclosure in which the components and/or operations are arranged and/or ordered differently than described and shown herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A lockdown kit for a load-bearing vehicle, comprising:
a base configured for attachment to a sidewall or a floor of the load-bearing vehicle;
a latch configured for attachment to the base;
a lever configured for movement from a first position to a second position, the lever engages with the latch to open and close the latch; and
a release cable configured for attachment to the lever.

2. The lockdown kit according to claim 1, wherein the release cable is configured to move the lever to open the latch.

3. The lockdown kit according to claim 1, wherein the latch is attached to the base at a predetermined height for engagement with a clampable extension from a load.

4. The lockdown kit according to claim 1, wherein the latch is attached to the base at a predetermined height for engagement with a grip portion or an eyelet of a load.

5. The lockdown kit according to claim 3, further comprising:
a solenoid configured to attach to the lever; and
a reader configured to actuate the solenoid to move the lever from the first position to a second position upon receiving a signal from a fob.

6. The lockdown kit according to claim 3, further comprising:
a solenoid configured to attach to the release cable; and
a reader configured to actuate the solenoid to move the release cable attached to the lever upon receiving a signal from a fob.

7. The lockdown kit according to claim 1, wherein the latch comprises a trunk latch.

8. The lockdown kit according to claim 1, wherein the release cable comprises a parking brake release cable.

9. The lockdown kit according to claim 1, further comprising one or more support blocks for mounting the base or the latch to the load-bearing vehicle.

10. A toolbox lockdown device for a load-bearing vehicle, the lockdown device comprising:
a latch arranged at a predetermined height;
a lever configured to engage and disengage the latch with a load based on a position of the lever; and
a release cable attached to the lever configured to disengage the latch.

11. The lockdown device according to claim 10, wherein the lever at a first position engages the latch with a clampable extension of the load, and the lever at a second position disengages the latch from the clampable extension of the load.

12. The lockdown device according to claim 10, further comprising a base configured for attachment to a sidewall or a floor of the load-bearing vehicle, wherein the latch is attached to the base.

13. The lockdown device according to claim 12, wherein the latch is attached to the base at a predetermined height for engagement with a clampable extension from a load.

14. The lockdown device according to claim 12, wherein the latch is attached to the base at a predetermined height for engagement with a grip portion or an eyelet of a load.

15. The lockdown device according to claim 12, wherein the base comprises one or more support blocks.

16. The lockdown device according to claim 11, wherein the release cable is configured to move the lever to open the latch.

17. The lockdown device according to claim 11, further comprising
a solenoid configured to attach to the lever; and
a reader configured to receive a signal from a fob and actuate the solenoid to move the lever from the first position to a second position.

18. The lockdown device according to claim 11, further comprising:
a solenoid configured to attach to the release cable; and
a reader configured to receive a signal from a fob and actuate the solenoid to move the release cable attached to the lever.

19. The lockdown device according to claim 10, wherein the latch comprises a trunk latch.

20. The lockdown device according to claim 10, wherein release cable comprises a parking brake release cable.
